(19) United States
(12) Patent Application Publication
(10) Pub. No.: US 2016/0234757 A1
(43) Pub. Date: Aug. 11, 2016

(54) DISCOVERING LONG TERM EVOLUTION (LTE) ADVANCED IN UNLICENSED SPECTRUM BASE STATIONS

(71) Applicant: QUALCOMM Incorporated, San Diego, CA (US)

(72) Inventors: Kiran Kumar SOMASUNDARAM, San Diego, CA (US); Nachiappan VALLIAPPAN, San Diego, CA (US); Naga BHUSHAN, San Diego, CA (US); Dexu LIN, San Diego, CA (US); Ahmed Kamel SADEK, San Diego, CA (US)

(21) Appl. No.: 14/620,146

(22) Filed: Feb. 11, 2015

(51) Int. Cl. H04W 48/08; H04W 12/10; H04W 16/14

(52) U.S. Cl. CPC H04W 48/08; H04W 16/14; H04W 12/10; H04W 88/10

(57) ABSTRACT

The present disclosure presents a method and an apparatus for transmitting discovery signaling from a base station. For example, the method may include encoding a wireless fidelity (Wi-Fi) beacon at the base station for transmission and transmitting the encoded Wi-Fi beacon from the base station to one or more neighboring wireless nodes. The Wi-Fi beacon is generated by a Wi-Fi access point (AP) co-located at the base station which is a long term evolution (LTE) or LTE advanced in unlicensed spectrum base station. As such, other wireless nodes can discover the LTE or LTE advanced in unlicensed spectrum base station.

### BACKGROUND

Aspects of the present disclosure relate generally to wireless communications, and more particularly, to long term evolution (LTE) advanced in unlicensed spectrum base stations.

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of eNodeBs that can support communication for a number of user equipments (UEs). A UE may communicate with an eNodeB via the downlink and uplink. The downlink (or forward link) refers to the communication link from the eNodeB to the UE, and the uplink (or reverse link) refers to the communication link from the UE to the eNodeB.

To supplement conventional base stations, additional restricted power or restricted coverage base stations, referred to as small coverage base stations or cells, can be deployed to provide more robust wireless coverage to mobile devices. For example, wireless relay stations and low power base stations (e.g., which can be commonly referred to as Home NodeBs or Home eNBs, collectively referred to as H(e)NBs, femto cells, pico cells, etc.) can be deployed for incremental capacity growth, richer user experience, in-building or other specific geographic coverage, and/or the like. Such low power or small coverage (e.g., relative to macro network base stations or cells) base stations can be connected to the Internet via broadband connection (e.g., digital subscriber line (DSL) router, cable or other modem, etc.), which can provide the backhaul link to the mobile operator's network. Thus, for example, the small coverage base stations can be deployed in user homes to provide mobile network access to one or more devices via the broadband connection. Because deployment of such base stations is unplanned, low power base stations can interfere with one another where multiple stations are deployed within a close vicinity of one another.

Different radio access technologies (RATs) may share the unlicensed spectrum. As a result, there is a need for nodes operating on one RAT (e.g., Wireless-Fidelity, Wi-Fi) to discover nodes operating on a different RAT (e.g., LTE Advanced in unlicensed spectrum) for co-existence purposes. For example, Wi-Fi access points (APs) have to discover the presence of LTE Advanced in unlicensed spectrum base stations in the vicinity. Therefore, there is a desire for nodes operating on one RAT to discover nodes operating on a different RAT when both nodes co-exist in the unlicensed spectrum.

### SUMMARY

The following presents a simplified summary of one or more aspects in order to provide a basic understanding of such aspects. This summary is not an extensive overview of all contemplated aspects, and is intended to neither identify key or critical elements of all aspects not delineate the scope of any or all aspects. Its sole purpose is to present some concepts of one or more aspects in a simplified form as a prelude to the more detailed description that is presented later.

The present disclosure presents an example method and apparatus for transmitting discovery signaling from a base station. For example, the present disclosure presents an example method for transmitting discovery signaling from a long term evolution (LTE) or

LTE advanced in unlicensed spectrum base station that may include encoding a wireless fidelity (Wi-Fi) beacon at the base station for transmission, wherein the Wi-Fi beacon is generated by a Wi-Fi access point (AP) co-located at the base station which is a long term evolution (LTE) or LTE advanced in unlicensed spectrum base station and transmitting the encoded Wi-Fi beacon from the base station to one or more neighboring wireless nodes.

Additionally, the present disclosure presents an example apparatus for transmitting discovery signaling from a base station that may include means for encoding a wireless fidelity (Wi-Fi) beacon at the base station for transmission, wherein the Wi-Fi beacon is generated by a Wi-Fi access point (AP) co-located at the base station which is a long term evolution (LTE) or LTE advanced in unlicensed spectrum base station and means for transmitting the encoded Wi-Fi beacon from the base station to one or more neighboring wireless nodes.

In a further aspect, the present disclosure presents an example non-transitory computer readable medium storing computer executable code for transmitting discovery signaling from a base station that may include code for encoding a wireless fidelity (Wi-Fi) beacon at the base station for transmission, wherein the Wi-Fi beacon is generated by a Wi-Fi access point (AP) co-located at the base station which is a long term evolution (LTE) or LTE advanced in unlicensed spectrum base station and code for transmitting the encoded Wi-Fi beacon from the base station to one or more neighboring wireless nodes.

Moreover, in an aspect, the presents disclosure presents an example apparatus for transmitting discovery signaling from a base station that may include an encoding component to encode a wireless fidelity (Wi-Fi) beacon at the base station for transmission, wherein the Wi-Fi beacon is generated by a Wi-Fi access point (AP) co-located at the base station which is a long term evolution (LTE) or LTE advanced in unlicensed spectrum base station and a transmission component to transmit the encoded Wi-Fi beacon from the base station to one or more neighboring wireless nodes.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram illustrating an example of a telecommunications system in accordance with an aspect of the present disclosure;

FIG. 2 is a flow diagram illustrating aspects of a method for transmitting discovery signals from a long term evolution (LTE) advanced in unlicensed spectrum base station in aspects of the present disclosure;

FIG. 3 is a block diagram illustrating aspects of a logical grouping of electrical components as contemplated by the present disclosure;

FIG. 4 is a block diagram conceptually illustrating an example of a downlink frame structure in a telecommunications system in accordance with an aspect of the present disclosure;

FIG. 5 is a block diagram illustrating aspects of an example base station including a discovery signal transmission manager according to the present disclosure;

FIG. 6 is a block diagram conceptually illustrating an example of a telecommunications system including a base station with a discovery signal transmission manager according to the present disclosure;

FIG. 7 is a conceptual diagram illustrating an example of an access network including a bases station with a discovery signal transmission manager according to the present disclosure; and

FIG. 8 is a block diagram conceptually illustrating an example of a NodeB in communication with a UE, which includes a discovery signal transmission manager according to the present disclosure, in a telecommunications system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known components are shown in block diagram form in order to avoid obscuring such concepts.

Aspects of the approach described herein may apply when wireless nodes (e.g., LTE or LTE advanced in unlicensed spectrum base stations or Wi-Fi APs) have to discover the presence of other LTE or LTE advanced in unlicensed spectrum base stations in their vicinity.

Method and apparatus are described in which an LTE or LTE advanced in unlicensed spectrum base station encodes a wireless fidelity (Wi-Fi) beacon and transmits the encoded Wi-Fi beacon to one more neighboring wireless nodes (e.g., LTE or LTE advanced in unlicensed spectrum base stations or Wi-Fi APs) for discovery by other wireless nodes in the vicinity. The Wi-Fi beacon may be generated at the base station by a co-located Wi-Fi AP and may be encoded with a RAT type of the base station using a reserved field of the Wi-Fi beacon. Additionally, a logical binding may be established between the Wi-Fi beacon and an LTE discovery signal of the base station by cryptographically encoding same information in the Wi-Fi beacon and the LTE discovery signal of the base station.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

In order to facilitate a fuller understanding of the present disclosure, reference is now made to the accompanying drawings, in which like elements are referenced with like numerals. These drawings should not be construed as limiting the present disclosure, but are intended to be illustrative only.

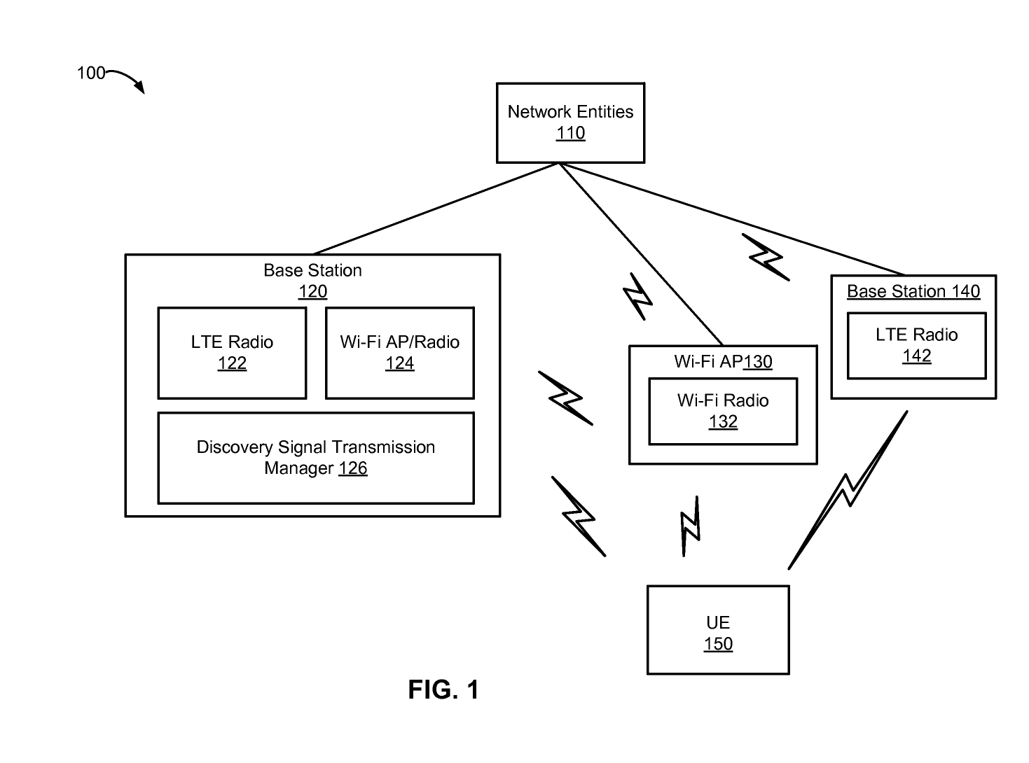

FIG. 1 illustrates several nodes of a sample communication system 100 (e.g., a portion of a communication network). For illustration purposes, various aspects of the disclosure will be described in the context of one or more access terminals, access points, and network entities that communicate with one another. It should be appreciated, however, that the teachings herein may be applicable to other types of apparatuses or other similar apparatuses that are referenced using other terminology. For example, in various implementations access points may be referred to or implemented as base stations, NodeBs, eNodeBs, Home NodeBs, Home eNodeBs, small cells, macro cells, femto cells, and so on, while access terminals may be referred to or implemented as user equipment (UEs), mobile stations, and so on.

The term “small cell,” as used herein, refers to a relatively low transmit power and/or a relatively small coverage area cell as compared to a transmit power and/or a coverage area of a macro cell. Further, the term “small cell” may include, but is not limited to, cells such as a femto cell, a pico cell, access point base stations, Home NodeBs, femto access points, or femto cells. For instance, a macro cell may cover a relatively large geographic area, such as, but not limited to, several kilometers in radius. In contrast, a pico cell may cover a relatively small geographic area, such as, but not limited to, a building. Further, a femto cell also may cover a relatively small geographic area, such as, but not limited to, a home, or a floor of a building.

The present disclosure relates in some aspects to techniques that facilitate transmitting discovery signals from a long term evolution (LTE) or LTE Advanced in unlicensed spectrum base station. For convenience, the use, operation, extension, and/or adaptation of LTE and/or LTE Advanced for applications in an unlicensed radio frequency (RF) band may be referred to herein as “LTE/LTE Advanced in unlicensed spectrum,” “adapting LTE/LTE Advanced in unlicensed spectrum,” “extending LTE/LTE Advanced to unlicensed spectrum,” and “LTE/LTE Advanced communications over unlicensed spectrum” etc. Moreover, a network or device that provides, adapts, or extends LTE/LTE Advanced in unlicensed spectrum may refer to a network or device that is configured to operate in a contention-based radio frequency band or spectrum.

In an aspect, the telecommunications system 100 may include various devices that may communicate using a shared portion of the spectrum. In one example, the shared portion of the spectrum may include an unlicensed portion of the spectrum. A shared portion of the spectrum may include any frequency band that, for example, allows usage by more than one technology or network. For example, devices may use a portion of a 5 GHz band, which may also be referred to as an unlicensed national information infrastructure (U-NII) radio band.

Nodes in the system 100 provide access to one or more services (e.g., network connectivity) for one or more wireless terminals (e.g., user equipment (UE) 150) that may be installed within or that may roam throughout a coverage area of the system 100. For example, at various points in time the UE 150 may connect to base station 120 or some other access point in the system 100, e.g., Wi-Fi AP 130 or base station 140.

One or more of the nodes may communicate with one or more network entities (represented, for convenience, by the network entities 110), including each other, to facilitate wide area network connectivity. Two or more of such network entities may be co-located and/or two or more of such network entities may be distributed throughout a network.

A network entity may take various forms such as, for example, one or more radio and/or core network entities. Thus, in various implementations the network entities 110 may represent functionality such as at least one of: network management (e.g., via an operation, administration, management, and provisioning entity), call control, session management, mobility management, gateway functions, interworking functions, or some other suitable network functionality. In some aspects, mobility management relates to: keeping track of the current location of access terminals through the use of tracking areas, location areas, routing areas, or some other suitable technique; controlling paging for access terminals; and providing access control for access terminals.

In an aspect, base station 120 may include an LTE radio 122, Wi-Fi radio 124, and/or a discovery signal transmission manager 126 for transmitting discovery signals from a long term evolution advanced in unlicensed spectrum base station. Wi-Fi AP 130 may include a Wi-Fi radio 132 and/or base station 140 may be an LTE base station (e.g., operating in the licensed spectrum) and may include an LTE radio 142. In an additional aspect, the base station may be a Listen Before Talk (LBT) or a non-LBT LTE advanced base station operating in the unlicensed spectrum.

When base station 120 co-exists in the unlicensed band with other nodes, for examples, Wi-Fi AP 130 and/or base station 140, base station 120 has to signal its presence to the other nodes in its vicinity (e.g., Wi-Fi AP 130 and/or base station 140). Such a signaling procedure allows the nodes to co-exist efficiently (e.g., reduces interference, etc.). In an aspect, to enable discovery of base station 120 operating by other nodes (e.g., Wi-Fi AP 130 and/or base station 140), base station 120 may transmit a Wi-Fi beacon using a co-located Wi-Fi AP or Wi-Fi radio 124 to inform other nodes (e.g., Wi-Fi AP 130 and/or base station 140) in the network about its presence.

In an aspect, base station 120 and/or discovery transmission manager 126 may encode a Wi-Fi beacon generated by Wi-Fi AP 124 co-located at base station 120 and transmit the encoded beacon from base station 120 to neighboring base stations or Wi-Fi APs (e.g., base station 140 and/or Wi-Fi AP 130). In an additional aspect, base station 120 and/or discovery transmission manager 126 may establish a logical binding between the Wi-Fi beacon and LTE discovery signals of the base station. For example, in an aspect, logical binding may be achieved by cryptographically encoding same information in the Wi-Fi beacon and the LTE discovery signals of the base station to avoid double counting by receiving nodes (e.g. receiving base stations and APs).

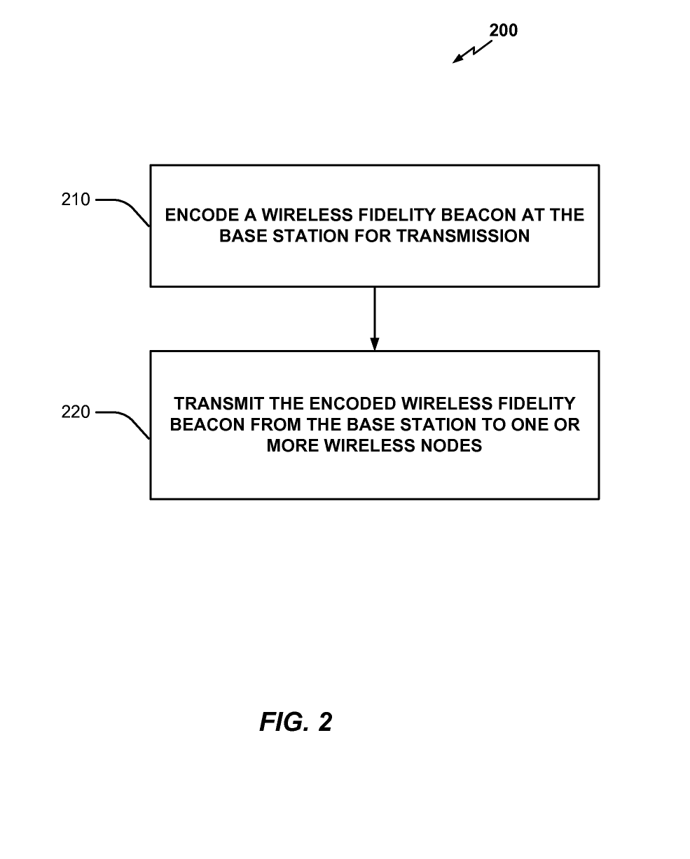

FIG. 2 illustrates an example methodology 200 for transmitting discovery signals from base station 200 of FIG. 1.

In an aspect, at block 202, methodology 200 may include encoding a beacon at a base station for transmission. For example, in an aspect, base station 120 and/or discovery signal transmission manager 116 may include a specially programmed processor module, or a processor executing specially programmed code stored in a memory, to encode a beacon at base station 110 for transmission. In an aspect, for example, base station 120 may include an LTE radio (or LTE Advanced radio) for LTE transmission/reception in the unlicensed spectrum and a co-located Wi-Fi AP 114 for generating and/or transmitting a Wi-Fi beacon.

In an aspect, base stations operating on different radio access technologies (RATs) may have to co-exist in the unlicensed spectrum. For example, Wi-Fi APs, LTE base stations, and/or LTE advanced in unlicensed spectrum base stations (e.g., LTE base stations operating in unlicensed spectrum). As the base stations operating on different RATs co-exist in the unlicensed spectrum, there is a need for signaling (e.g., notifying) presence of a wireless node (e.g., base station, AP, etc.) to other wireless nodes in the vicinity (e.g., coverage area). The notification may be used for triggering co-existence solutions, e.g., smart channel selection, listen before talk (LBT), etc.

In an aspect, the radio access technology (RAT) type of the base station (e.g., LTE or LTE Advanced in unlicensed spectrum) may be encoded in the Wi-Fi beacon. For example, service set identifier (SSID) field of the Wi-Fi beacon may be encoded with the RAT type of the base station. For example, SSID field of the Wi-Fi beacon of LTE eNodeB may be encoded with “LTE.” The encoding of the SSID field of the Wi-Fi beacon with the RAT type of the base station indicates to the neighboring nodes (e.g., base stations and/or APs) that the node transmitting the Wi-Fi beacon is associated with an LTE eNodeB. In an additional or optional aspect, additional information encoded into the Wi-Fi beacon may indicate that the Wi-Fi beacon is associated with a “phantom AP” which may be co-located with an LTE eNodeB. That is, the node is an LTE eNodeB transmitting the Wi-Fi beacon to assist with discovery, but not a real Wi-Fi AP. In a further additional or optional aspect, the encoding may assist the receiving nodes to differentiate between different types of base station (e.g., between Listen Before Talk (LBT) and non-LBT LTE base stations operating in the unlicensed spectrum.

In an aspect, at block 204, methodology 200 may include transmitting the encoded Wi-Fi beacon from the base station to one or more neighboring wireless nodes. For example, in an aspect, base station 120 and/or discovery signal transmission manager 126 may include a specially programmed processor module, or a processor executing specially programmed code stored in a memory, to transmit the encoded Wi-Fi beacon from the base station to one or more neighboring wireless nodes (e.g., LTE or LTE Advanced in unlicensed spectrum base stations or Wi-Fi APs).

In an aspect, base station 120 may transmit an encoded Wi-Fi beacon to enable discovery of base station 120 by other base stations (e.g., base station 140) and/or APs (e.g., AP 130). In an additional aspect, identical beacon signatures may be used to aid Wi-Fi channel selection. For example, in an aspect, this may be achieved by spoofing the beacon base service set identifier (BSSID) of co-located APs to appear as one network. In an aspect, beacon power back-off may be used to aid Wi-Fi deferral computation. For example, in an aspect, beacon power back-off may be used to influence Wi-Fi deferral computation. For instance, LTE radio 122 and Wi-Fi AP 124 (of base station 120) may be respectively transmitting LTE signals and Wi-Fi beacon at a similar power level (e.g., 20 dBm). On the receiving side, Wi-Fi AP 130 may detect the Wi-Fi beacon transmitted by Wi-Fi AP 124 as the received power of the Wi-Fi beacon is above a threshold value (e.g., −82 dBm) for detection by Wi-Fi AP 130. Once Wi-Fi AP 130 detects the Wi-Fi beacon, Wi-Fi AP 130 may assume that it will start sharing the channel (e.g., frequency used by transmitting the Wi-Fi beacon) with Wi-Fi AP 124, e.g., by performing a time division multiplexing (TDM) of the channel. However, since Wi-Fi AP 124 is a phantom AP (that is, not a regular Wi-Fi AP but just used for transmitting a Wi-Fi beacon), transmissions by LTE Radio 122 of base station 120 may collide with transmissions of Wi-Fi AP 130 because the threshold for energy detection and back-off to non-Wi-Fi signals at Wi-Fi AP 130 is higher (e.g., −62 dBm) than Wi-Fi beacons. Therefore, in an aspect, the transmit power of the Wi-Fi beacon may be reduced, e.g., by 20 dB, so that the received power of the Wi-Fi beacon at Wi-Fi AP 130 is below the preamble detection threshold value (e.g., −82 dBm) for detection by Wi-Fi AP 130. This power back-off prevents Wi-Fi AP 130 from false assuming that it would share the channel or frequency with another (phantom) Wi-Fi AP. Further, the reduced transmit power of the Wi-Fi beacon has an effect of influencing the behavior of only Wi-Fi APs in the vicinity that would truly share the channel, e.g., by performing a time division multiplexing (TDM) of the channel, with LTE.

In an aspect, logical binding (e.g., unique logical binding) may be created between the LTE discovery signals transmitted by LTE radio 122 and Wi-Fi beacon transmitted by Wi-Fi radio 124. For example, base station 120 may transmit Wi-Fi beacons (e.g., via co-located Wi-Fi AP 124) in addition to LTE discovery signals (e.g., contention exempt transmission (CETs)) with a logical binding between these two signals to assist the nodes that are receiving these two signals to distinguish between the LTE discovery signal and Wi-Fi beacon from base station 120. This may prevent double counting of nodes on the receiving side based of the Wi-Fi beacon and the LTE discovery signal by a neighboring base station (e.g., base station 140) and/or a Wi-Fi AP (e.g., AP 130).

For example, in an aspect, the logical binding may be achieved by encoding same information in one of the fixed fields (e.g., timestamp, sequence number, reserved fields, etc.) of the Wi-Fi beacon (e.g., of the Wi-Fi radio 124) and the LTE discovery signal of base station 120. This match allows the identity of the Wi-Fi beacon to be validated. For example, in an aspect, a unique pass phrase created by a hash on channel number, UTRAN cell global identifier (eCGI), current time stamp or a random number generated with a secure seed may be used. In an additional aspect, cryptographic information exchange may prevent replay attacks by malicious attacks and improve performance, stability, and reliability of the system.

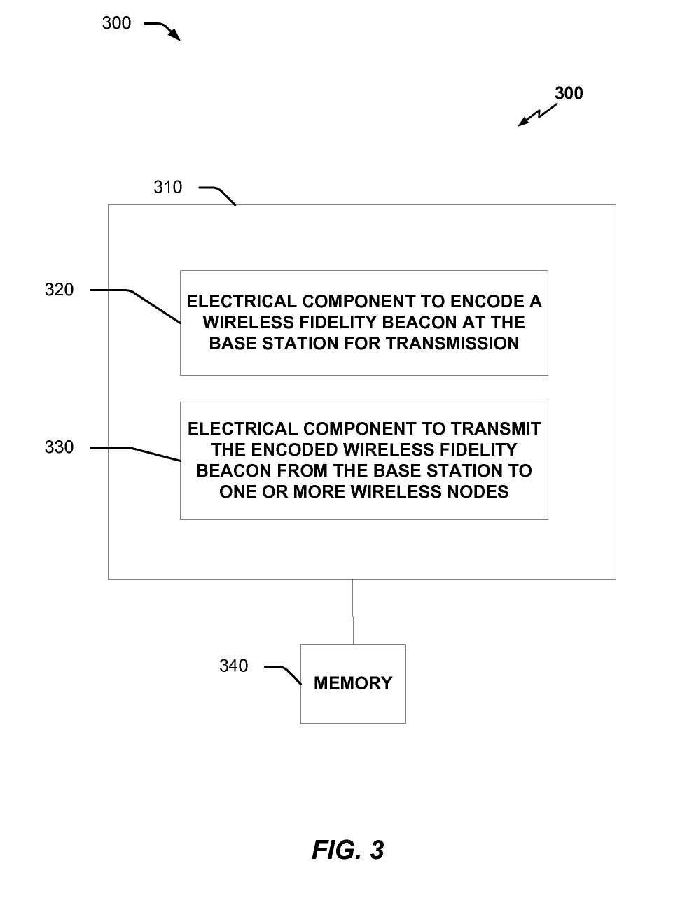

Referring to FIG. 3, an example system 300 for transmitting discovery signals from an LTE advanced in unlicensed spectrum base station is illustrated. The system 300 may be included in base station 120. It is to be appreciated that system 300 is represented as including functional blocks, which can be functional blocks that represent functions implemented by a processor, software, or combination thereof (for example, firmware). System 300 includes a logical grouping 310 of electrical components that can act in conjunction. For instance, logical grouping 310 can include an electrical component 320 for encoding a wireless fidelity (Wi-Fi) beacon at the base station for transmission. For example, in an aspect, the Wi-Fi beacon is generated by a Wi-Fi access point (AP) co-located at the base station which is an LTE or LTE advanced in unlicensed spectrum base station. In an aspect, electrical component 310 may comprise discovery signal transmission manager 126 and/or an encoding component 128 (FIG. 1).

Additionally, logical grouping 310 can include an electrical component 330 for transmitting the encoded beacon from the base station to neighboring wireless nodes. In an aspect, the electrical component 330 may comprise discovery signal transmission manager 126 and/or a beacon transmitting component 129 (FIG. 1).

Additionally, system 300 can include a memory 340 that retains instructions for executing functions associated with the electrical components 320 and 330, and stores data used or obtained by the electrical components 320 and 330. While shown as being external to memory 340, it is to be understood that one or more of the electrical components 320 and 330 can exist within memory 340. In one example, electrical components 320 and 330 can comprise at least one processor, or each electrical component 320 and 330 can be a corresponding module of at least one processor. Moreover, in an additional or alternative example, electrical components 320 and 330 can be a computer program product including a computer readable medium (e.g., non-transitory computer readable medium), where each electrical component 320 and 330 can be corresponding code.

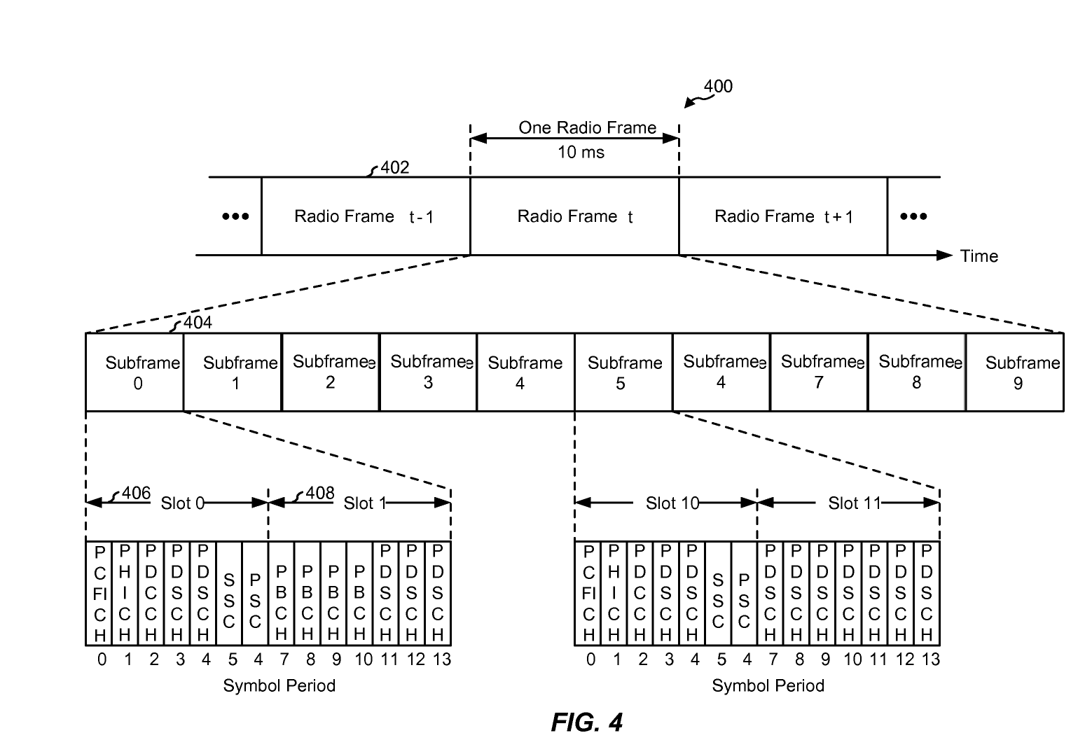

FIG. 4 is a block diagram conceptually illustrating an example of a downlink frame structure in a telecommunications system in accordance with an aspect of the present disclosure. The transmission timeline for the downlink may be partitioned into units of radio frames 402. Each radio frame 402 may have a predetermined duration (e.g., 10 milliseconds (ms)) and may be partitioned into 10 sub-frames 404 with indices of 0 through 9. Each sub-frame 404 may include two slots 406 and 408. Each radio frame may thus include 20 slots with indices of 0 through 19. Each slot may include L symbol periods, e.g., 7 symbol periods for a normal cyclic prefix (as shown in FIG. 4) or 14 symbol periods for an extended cyclic prefix (not shown). The 2L symbol periods in each sub-frame 404 may be assigned indices of 0 through 2L−1. The available time frequency resources may be partitioned into resource blocks. Each resource block may cover N subcarriers (e.g., 12 subcarriers) in one slot.

As discussed above, an LTE receiver (e.g., of LTE radio 122) may use a frame structure to provide a channel estimate. For example, an LTE receiver may estimate an LTE channel based on allocated resource blocks. The LTE receiver may estimate a channel condition for each allocated resource block.

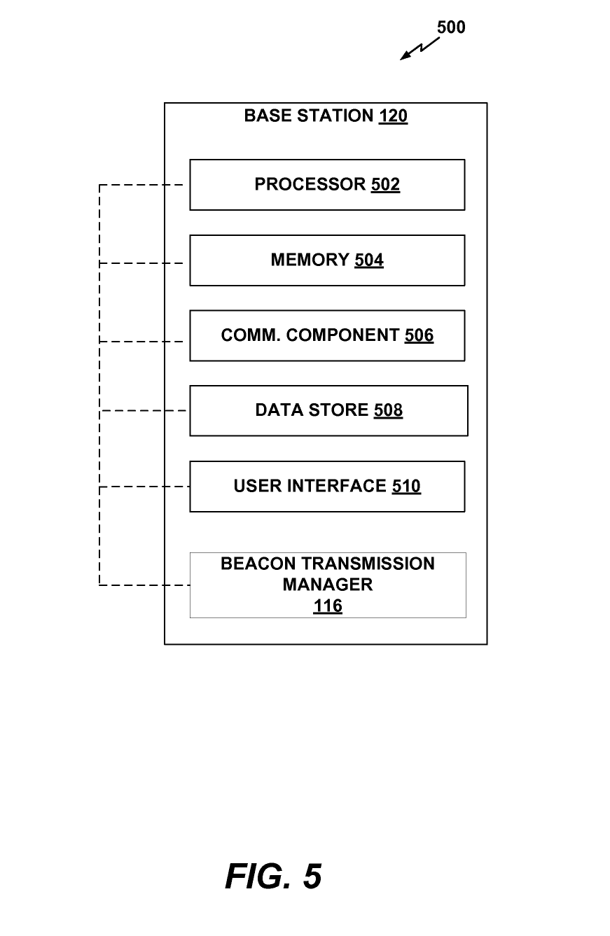

Referring to FIG. 5, in an aspect, base station 120 (FIG. 1), for example, including discovery signal transmission manager 126 (FIG. 1) may be or may include a specially programmed or configured computer device to perform the functions described herein. In one aspect of implementation, base station 120 may include discovery signal transmission manager 126 and its sub-components, including an encoding component 552, a transmission component 554, and/or a logical binding component, such as in specially programmed computer readable instructions or code, firmware, hardware, or some combination thereof.

In an aspect, for example as represented by the dashed lines, discovery signal transmission manager 126 may be implemented in or executed using one or any combination of processor 502, memory 504, communications component 506, and data store 508. For example, discovery signal transmission manager 126 may be defined or otherwise programmed as one or more processor modules of processor 502. Further, for example, discovery signal transmission manager 126 may be defined as a computer-readable medium (e.g., a non-transitory computer-readable medium) stored in memory 504 and/or data store 508 and executed by processor 502. Moreover, for example, inputs and outputs relating to operations of discovery signal transmission manager 126 may be provided or supported by communications component 506, which may provide a bus between the components of computer device 500 or an interface for communication with external devices or components.

Base station 120 may include processor 502 specially configured to carry out processing functions associated with one or more of components and functions described herein. Processor 502 can include a single or multiple set of processors or multi-core processors. Moreover, processor 502 can be implemented as an integrated processing system and/or a distributed processing system.

Base station 120 further includes memory 504, such as for storing data used herein and/or local versions of applications and/or instructions or code being executed by processor 502, such as to perform the respective functions of the respective entities described herein. Memory 504 can include any type of memory usable by a computer, such as random access memory (RAM), read only memory (ROM), tapes, magnetic discs, optical discs, volatile memory, non-volatile memory, and any combination thereof.

Further, base station 120 includes communications component 506 that provides for establishing and maintaining communications with one or more parties utilizing hardware, software, and services as described herein. Communications component 506 may carry communications between components on base station 120, as well as between user and external devices, such as devices located across a communications network and/or devices serially or locally connected to base station 120. For example, communications component 506 may include one or more buses, and may further include transmit chain components and receive chain components associated with a transmitter and receiver, respectively, or a transceiver, operable for interfacing with external devices.

Additionally, base station 120 may further include data store 508, which can be any suitable combination of hardware and/or software, that provides for mass storage of information, databases, and programs employed in connection with aspects described herein. For example, data store 508 may be a data repository for applications not currently being executed by processor 502.

Base station 120 may additionally include a user interface component 510 operable to receive inputs from a user of base station 120, and further operable to generate outputs for presentation to the user. User interface component 510 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 510 may include one or more output devices, including but not limited to a display, a speaker, a haptic feedback mechanism, a printer, any other mechanism capable of presenting an output to a user, or any combination thereof.

The various concepts presented throughout this disclosure may be implemented across a broad variety of telecommunication systems, network architectures, and communication standards.

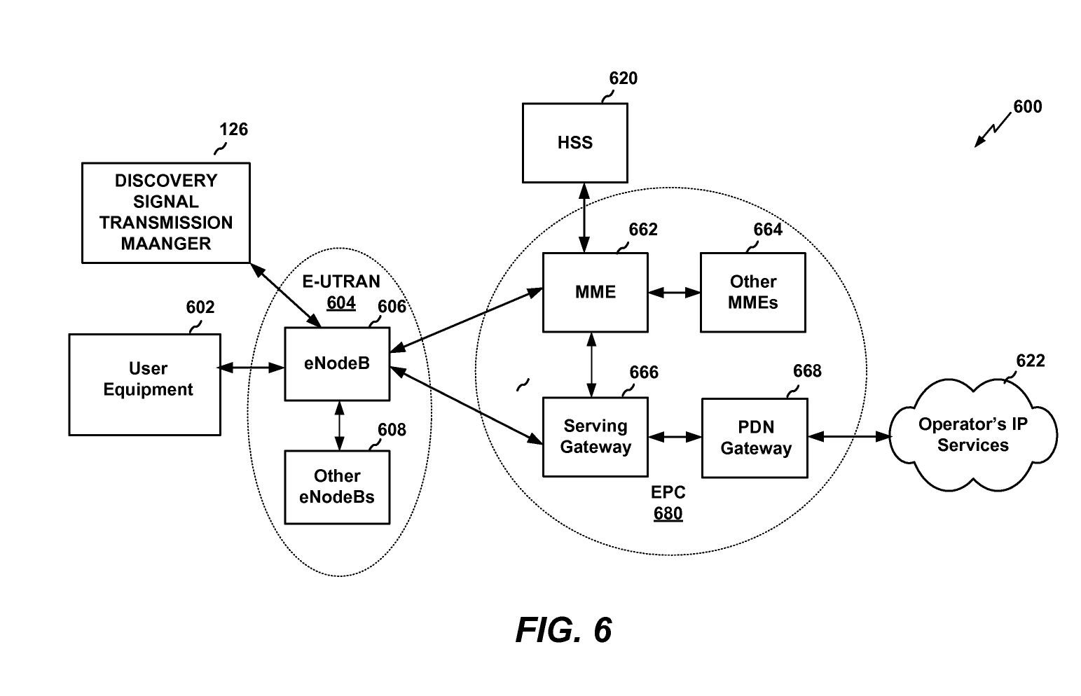

FIG. 6 is a diagram illustrating a long term evolution (LTE) network architecture 600 employing various apparatuses of wireless communication system 100 (FIG. 1) and may include one or more eNodeBs 606, which may be similar to or same as base station 120 (FIG. 1). The LTE network architecture 600 may be referred to as an Evolved Packet System (EPS) 600. EPS 600 may include one or more user equipment (UE) 602, an Evolved UMTS Terrestrial Radio Access Network (E-UTRAN) 604, an Evolved Packet Core (EPC) 680, a Home Subscriber Server (HSS) 620, and an Operator's IP Services 622. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 606 and other eNBs 608. The eNB 606 and 608 may each be an example of base station 120 (FIG. 1) including a discovery signal transmission manager 126 for transmitting discovery signals from a long term evolution advanced in unlicensed spectrum base station. The eNB 606 provides user and control plane protocol terminations toward the UE 602. The eNB 606 may be connected to the other eNBs 608 via an X2 interface (i.e., backhaul). The eNB 606 may also be referred to by those skilled in the art as a base station, a base transceiver station, a radio base station, a radio transceiver, a transceiver function, a basic service set (BSS), a small cell, an extended service set (ESS), or some other suitable terminology. The eNB 606 provides an access point to the EPC 680 for a UE 602. Examples of UEs 602 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 602 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 606 is connected by an S1 interface to the EPC 680. The EPC 680 includes a Mobility Management Entity (MME) 662, other MMEs 664, a Serving Gateway 666, and a Packet Data Network (PDN) Gateway 668. The MME 662 is the control node that processes the signaling between the UE 602 and the EPC 680. Generally, the MME 662 provides bearer and connection management. All user IP packets are transferred through the Serving Gateway 666, which itself is connected to the PDN Gateway 668. The PDN Gateway 668 provides UE IP address allocation as well as other functions. The PDN Gateway 668 is connected to the Operator's IP Services 622. The Operator's IP Services 622 includes the Internet, the Intranet, an IP Multimedia Subsystem (IMS), and a PS Streaming Service (PSS).

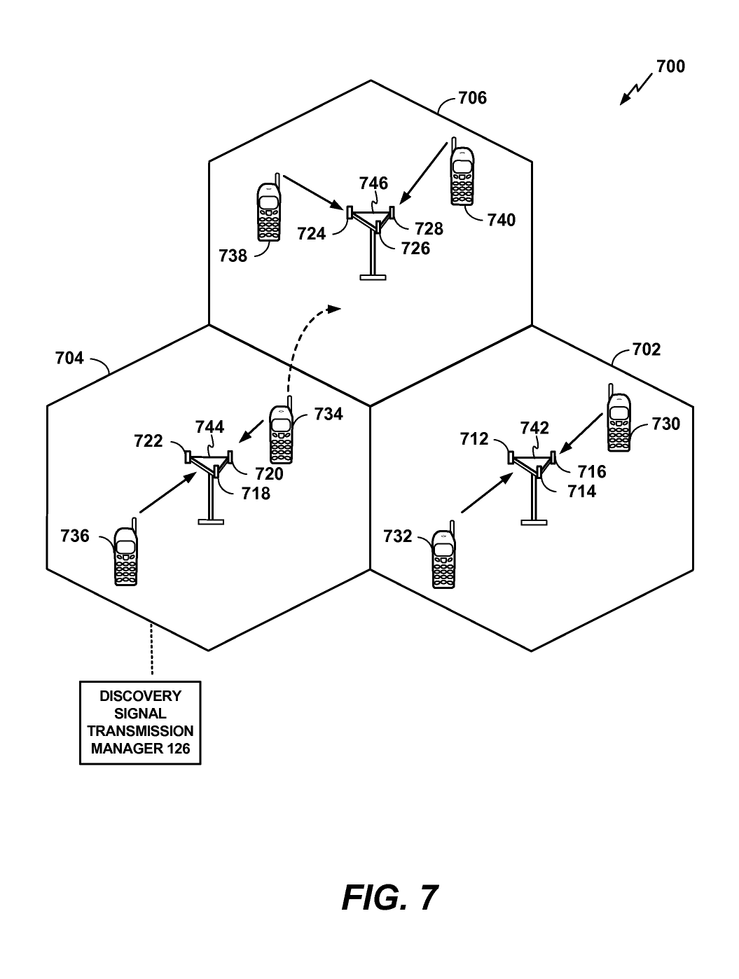

Referring to FIG. 7, an access network 700 in a UTRAN architecture is illustrated, and may include one or more LTE eNodeBs 120 (FIG. 1). The multiple access wireless communication system includes multiple cellular regions (cells), including cells 702, 704, and 706, each of which may include one or more sectors, and which may be the same as or similar to base station 120 (FIG. 1) in that they are configured to include discovery signal transmission manager 126 (FIG. 1; for example, illustrated here as being associated with cell 704) for transmitting discovery signals. The multiple sectors can be formed by groups of antennas with each antenna responsible for communication with UEs in a portion of the cell. For example, in cell 702, antenna groups 712, 714, and 716 may each correspond to a different sector. In cell 704, antenna groups 718, 720, and 722 each correspond to a different sector.

In cell 706, antenna groups 724, 726, and 728 each correspond to a different sector. The cells 702, 704, and 706 may include several wireless communication devices, e.g., UEs, for example, including access terminals which may be in communication with one or more sectors of each cell 702, 704, or 706. For example, UEs 730 and 732 may be in communication with NodeB 742, UEs 734 and 736 may be in communication with NodeB 744, and UEs 738 and 740 can be in communication with NodeB 746. Here, each NodeB 742, 744, and 746 is configured to provide an access point for all the UEs 730, 732, 734, 736, 738, and 740 in the respective cells 702, 704, and 706. Additionally, each of UEs 730, 732, 734, 736, 738, and 740 may be an example of access terminal and may perform the methods outlined herein.

As the UE 734 moves from the illustrated location in cell 704 into cell 706, a serving cell change (SCC) or handover may occur in which communication with the UE 734 transitions from the cell 704, which may be referred to as the source cell, to cell 706, which may be referred to as the target cell. Management of the handover procedure may take place at the UE 734, at the Node Bs corresponding to the respective cells, at EPC 680 (FIG. 6), or at another suitable node in the wireless network. For example, during a call with the source cell 704, or at any other time, the UE 734 may monitor various parameters of the source cell 704 as well as various parameters of neighboring cells such as cells 706 and 702. Further, depending on the quality of these parameters, the UE 734 may maintain communication with one or more of the neighboring cells. During this time, the UE 734 may maintain an Active Set, that is, a list of cells that the UE 734 is simultaneously connected to (i.e., the UTRA cells that are currently assigning a downlink dedicated physical channel DPCH or fractional downlink dedicated physical channel F-DPCH to the UE 734 may constitute the Active Set).

Further, the modulation and multiple access scheme employed by the access network 700 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

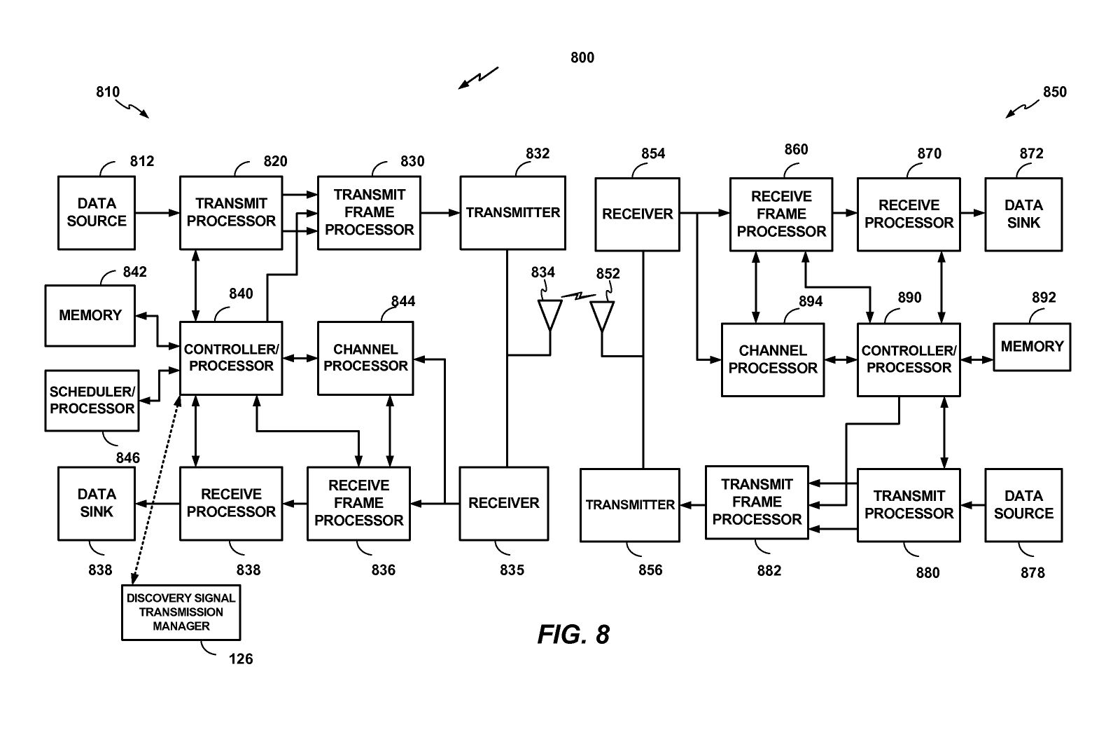

FIG. 8 is a block diagram of a Node B 810 in communication with a UE 850, where the Node B 810 may be base station 120 of FIG. 1 and/or UE 850 may the same or similar to UE 150 of FIG. 1, in that the Node B 810 is configured to include discovery signal transmission manager 126 for transmitting discovery signals. In the downlink communication, a transmit processor 820 may receive data from a data source 812 and control signals from a controller/processor 840. The transmit processor 820 provides various signal processing functions for the data and control signals, as well as reference signals (e.g., pilot signals).

For example, the transmit processor 820 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 944 may be used by a controller/processor 840 to determine the coding, modulation, spreading, and/or scrambling schemes for the transmit processor 820. These channel estimates may be derived from a reference signal transmitted by the UE 850 or from feedback from the UE 850. The symbols generated by the transmit processor 820 are provided to a transmit frame processor 830 to create a frame structure. The transmit frame processor 830 creates this frame structure by multiplexing the symbols with information from the controller/processor 840, resulting in a series of frames. The frames are then provided to a transmitter 832, which provides various signal conditioning functions including amplifying, filtering, and modulating the frames onto a carrier for downlink transmission over the wireless medium through antenna 834. The antenna 834 may include one or more antennas, for example, including beam steering bidirectional adaptive antenna arrays or other similar beam technologies.

At UE 850, a receiver 854 receives the downlink transmission through an antenna 852 and processes the transmission to recover the information modulated onto the carrier. The information recovered by the receiver 854 is provided to a receive frame processor 860, which parses each frame, and provides information from the frames to a channel processor 894 and the data, control, and reference signals to a receive processor 870. The receive processor 870 then performs the inverse of the processing performed by the transmit processor 820 in the Node B 810. More specifically, the receive processor 870 descrambles and de-spreads the symbols, and then determines the most likely signal constellation points transmitted by the Node B 810 based on the modulation scheme. These soft decisions may be based on channel estimates computed by the channel processor 894. The soft decisions are then decoded and de-interleaved to recover the data, control, and reference signals. The CRC codes are then checked to determine whether the frames were successfully decoded. The data carried by the successfully decoded frames will then be provided to a data sink 872, which represents applications running in the UE 850 and/or various user interfaces (e.g., display). Control signals carried by successfully decoded frames will be provided to a controller/processor 890. When frames are unsuccessfully decoded by the receive processor 870, the controller/processor 890 may also use an acknowledgement (ACK) and/or negative acknowledgement (NACK) protocol to support retransmission requests for those frames.

In the uplink, data from a data source 878 and control signals from the controller/processor 890 are provided to a transmit processor 880. The data source 878 may represent applications running in the UE 850 and various user interfaces (e.g., keyboard). Similar to the functionality described in connection with the downlink transmission by the Node B 810, the transmit processor 880 provides various signal processing functions including CRC codes, coding and interleaving to facilitate FEC, mapping to signal constellations, spreading with OVSFs, and scrambling to produce a series of symbols. Channel estimates, derived by the channel processor 894 from a reference signal transmitted by the Node B 810 or from feedback contained in the midamble transmitted by the Node B 810, may be used to select the appropriate coding, modulation, spreading, and/or scrambling schemes. The symbols produced by the transmit processor 880 will be provided to a transmit frame processor 882 to create a frame structure. The transmit frame processor 882 creates this frame structure by multiplexing the symbols with information from the controller/processor 890, resulting in a series of frames. The frames are then provided to a transmitter 856, which provides various signal conditioning functions including amplification, filtering, and modulating the frames onto a carrier for uplink transmission over the wireless medium through the antenna 852.

The uplink transmission is processed at the Node B 810 in a manner similar to that described in connection with the receiver function at the UE 850. A receiver 835 receives the uplink transmission through the antenna 834 and processes the transmission to recover the information modulated onto the carrier. The information recovered by the receiver 835 is provided to a receive frame processor 836, which parses each frame, and provides information from the frames to the channel processor 844 and the data, control, and reference signals to a receive processor 838. The receive processor 838 performs the inverse of the processing performed by the transmit processor 880 in the UE 850. The data and control signals carried by the successfully decoded frames may then be provided to a data sink 838 and the controller/processor, respectively. If some of the frames were unsuccessfully decoded by the receive processor, the controller/processor 840 may also use an acknowledgement (ACK) and/or negative acknowledgement (NACK) protocol to support retransmission requests for those frames.

The controller/processors 840 and 890 may be used to direct the operation at the Node B 810 and the UE 850, respectively. For example, the controller/processors 840 and 890 may provide various functions including timing, peripheral interfaces, voltage regulation, power management, and other control functions. The computer readable media of memories 842 and 892 may store data and software for the Node B 810 and the UE 850, respectively. A scheduler/processor 846 at the Node B 810 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for transmitting discovery signaling from a base station, comprising:
encoding a wireless fidelity (Wi-Fi) beacon at the base station for transmission, wherein the Wi-Fi beacon is generated by a Wi-Fi access point (AP) co-located at the base station which is a long term evolution (LTE) or an LTE advanced in unlicensed spectrum base station; and
transmitting the encoded Wi-Fi beacon from the base station to one or more neighboring wireless nodes.

2. The method of claim 1, wherein the encoding includes encoding a reserved field of the Wi-Fi beacon with a radio access technology (RAT) type of the base station.

3. The method of claim 2, wherein the reserved field is a service set identifier (SSID) field of the Wi-Fi beacon.

4. The method of claim 1, wherein a base service set identifier (BSSID) of the Wi-Fi beacon is used as a shared signature by a Wi-Fi beacon associated with another LTE or LTE advanced in unlicensed spectrum base station.

5. The method of claim 1, wherein the Wi-Fi beacon is transmitted at a reduced power.

6. The method of claim 1, further comprising:
establishing a logical binding between the Wi-Fi beacon and an LTE discovery signal of the base station.

7. The method of claim 6, wherein the logical binding includes cryptographically encoding same information in the Wi-Fi beacon and the LTE discovery signal of the base station.

8. The method of claim 6, wherein the discovery signal includes a contention exempt transmission (CET).

9. An apparatus for transmitting discovery signaling from a base station, comprising:
means for encoding a wireless fidelity (Wi-Fi) beacon at the base station for transmission, wherein the Wi-Fi beacon is generated by a Wi-Fi access point (AP) co-located at the base station which is a long term evolution (LTE) or an LTE advanced in unlicensed spectrum base station; and
means for transmitting the encoded Wi-Fi beacon from the base station to one or more neighboring wireless nodes.

10. The apparatus of claim 9, wherein the means for encoding includes means for encoding a reserved field of the Wi-Fi beacon with a radio access technology (RAT) type of the base station.

11. The apparatus of claim 10, wherein the reserved field is a service set identifier (SSID) field of the Wi-Fi beacon.

12. The apparatus of claim 9, wherein a base service set identifier (BSSID) of the Wi-Fi beacon is used as a shared signature by a Wi-Fi beacon associated with another LTE or LTE advanced in unlicensed spectrum base station.

13. The apparatus of claim 9, wherein the Wi-Fi beacon is transmitted at a reduced power.

14. The apparatus of claim 9, further comprising:
means for establishing a logical binding between the Wi-Fi beacon and an LTE discovery signal of the base station.

15. The apparatus of claim 14, wherein the discovery signal includes a contention exempt transmission (CET).

16. A non-transitory computer readable medium storing computer executable code for transmitting discovery signaling from a base station, comprising:
code for encoding a wireless fidelity (Wi-Fi) beacon at the base station for transmission, wherein the Wi-Fi beacon is generated by a Wi-Fi access point (AP) co-located at the base station which is a long term evolution (LTE) or LTE advanced in unlicensed spectrum base station; and
code for transmitting the encoded Wi-Fi beacon from the base station to one or more neighboring wireless nodes.

17. The computer readable medium of claim 16, wherein the code for encoding includes code for encoding a reserved field of the Wi-Fi beacon with a radio access technology (RAT) type of the base station.

18. The computer readable medium of claim 17, wherein the reserved field is a service set identifier (SSID) field of the Wi-Fi beacon.

19. The computer readable medium of claim 16, wherein a base service set identifier (BSSID) of the Wi-Fi beacon is used as a shared signature by a Wi-Fi beacon associated with another LTE or LTE advanced in unlicensed spectrum base station.

20. The computer readable medium of claim 17, wherein the Wi-Fi beacon is transmitted at a reduced power.

21. The computer readable medium of claim 17, further comprising:
code for establishing a logical binding between the Wi-Fi beacon and an LTE discovery signal of the base station.

22. The computer readable medium of claim 21, wherein the discovery signal includes a contention exempt transmission (CET).

23. An apparatus for transmitting a discovery signaling from a base station, comprising:
an encoding component to encode a wireless fidelity (Wi-Fi) beacon at the base station for transmission, wherein the Wi-Fi beacon is generated by a Wi-Fi access point (AP) co-located at the base station which is a long term evolution (LTE) or LTE advanced in unlicensed spectrum base station; and
a transmission component to transmit the encoded Wi-Fi beacon from the base station to one or more neighboring wireless nodes.

24. The apparatus of claim 23, wherein the encoding component is further configured to encode a reserved field of the Wi-Fi beacon with a radio access technology (RAT) type of the base station.

25. The apparatus of claim 24, wherein the reserved field is a service set identifier (SSID) field of the Wi-Fi beacon.

26. The apparatus of claim 23, wherein a base service set identifier (BSSID) of the Wi-Fi beacon is used as a shared signature by a Wi-Fi beacon associated with another LTE or LTE advanced in unlicensed spectrum base station.

27. The apparatus of claim 23, wherein the Wi-Fi beacon is transmitted at a reduced power.

28. The apparatus of claim 23, further comprising:
a logical binding component to establish a logical binding between the Wi-Fi beacon and an LTE discovery signal of the base station.

29. The apparatus of claim 28, wherein the discovery signal includes a contention exempt transmission (CET).

30. The apparatus of claim 28, wherein the logical binding component is further configured to cryptographically encode same information in the Wi-Fi beacon and the LTE discovery signal of the base station.
